(19) United States
(12) Patent Application Publication
(10) Pub. No.: US 2025/0134157 A1
(43) Pub. Date: May 1, 2025

(54) METHOD AND APPARATUS FOR SHREDDING A SHEET OF MATERIAL

(71) Applicant: NICOVENTURES TRADING LIMITED, London (GB)

(72) Inventors: Benjamin JENKINS, London (GB); Robert CHMIELEWSKI, Radom (PL); Wojciech FRUZYNSKI, Radom (PL)

(21) Appl. No.: 18/835,530

(22) PCT Filed: Feb. 1, 2023
(86) PCT No.: PCT/GB2023/050221

§ 371 Date: Aug. 2, 2024

(30) Foreign Application Priority Data
Feb. 3, 2022 (GB) 2201391.6

(51) Int. Cl. A24B 7/12; A24C 5/18

(52) U.S. Cl. CPC A24B 7/12; A24C 5/1828

(57) ABSTRACT

A method and apparatus for shredding a sheet of material. The material may be employed as an aerosol generating material in a consumable for use in a non-combustible aerosol provision system. The method includes the steps of perforating the sheet in a first direction with a plurality of parallel lines of perforations to form a perforated sheet, the perforations of adjacent lines being offset from one another, and cutting the perforated sheet in a second direction to form individual strips of material. The first and second directions may be orthogonal, for example machine direction and cross direction.

### RELATED APPLICATIONS

The present application is a National Phase entry of PCT Application No. PCT/GB2023/050221 filed Feb. 1, 2023, which claims priority to GB Application No. 2201391.6 filed Feb. 3, 2022, each of which is hereby incorporated by reference in their entirety.

### TECHNICAL FIELD

The present disclosure relates to a method and apparatus for shredding a sheet of material. The material may be employed as an aerosol generating material in a consumable for use in a non-combustible aerosol provision system.

### BACKGROUND

Certain delivery systems produce an aerosol during use, which is inhaled by a user. For example, tobacco heating devices heat an aerosol generating material such as tobacco to form an aerosol by heating, but not burning, the material. Such delivery systems commonly include a heating device with a heating element, which, when heated, heats the aerosol-generating material to release an aerosol. The aerosol generating material may additionally or alternatively comprise an amorphous solid.

The aerosol generating material may be in the form of strands or strips. The present invention provides a method and apparatus for forming such strands or strips from a sheet of the material. Although the invention is suitable for use in the formation of strands or strips of aerosol generating material, the invention is not limited to such material and may be employed in any context where strands or strips of material are to be formed from a sheet.

### SUMMARY

In accordance with some embodiments, a method of shredding a sheet of material is provided, comprising the steps of: perforating the sheet in a first direction with a plurality of parallel lines of perforations to form a perforated sheet, wherein the perforations of adjacent lines are offset from one another; and cutting the perforated sheet in a second direction to form individual strips of material.

The sheet may be a discrete sheet of material or may be in the form of a continuous web, e.g. fed from a roll of material. While a roll of material has a finite length, it may be considered to be continuous, compared to a discrete sheet of material for example.

The method forms individual strips, strands or fibers of material from the sheet. The term strips will be employed for simplicity. The dimensions of the strips are not critical to the invention and the invention may be employed to form strips of any shape or size. In general, the strips may be rectangular in shape and may have a length dimension which is multiple times the width dimension. In one embodiment, the strip is about 1 mm wide by about 40 mm long. The length of the strip may be defined as the target length, which is the desired length of the strips formed by the invention. In some embodiments, not all the strips have the target length but a majority have the target length. This is discussed further below.

The material from which the sheet and the strips are made is not critical to the invention. In some embodiments, the material is an aerosolizable material. Aerosolizable materials are discussed further below. In some embodiments the sheet comprises an amorphous solid material, also discussed further below.

Although the first and second directions may be oriented in any direction relative to one another, in some embodiments the first and second directions are orthogonal. When the first and second directions are orthogonal, the strips formed by the invention will be square or rectangular.

In some embodiments, the sheet of material is supplied in a machine direction. In general, the machine direction is the direction of travel of the material through the process or apparatus. The cross direction is orthogonal to the machine direction and is generally the direction across the apparatus. The machine direction may be referred to as the longitudinal direction and the cross direction referred to as the transverse direction.

In some embodiments, the first direction is the machine direction and the second direction is the cross direction. The lines of perforations are therefore formed in the machine direction and the second cut is in the cross direction.

In other embodiments, the first direction is the cross direction and the second direction is the machine direction. The lines of perforations are therefore formed in the cross direction and the second cut is in the machine direction.

In some embodiments, the line of perforations in the first direction can be regarded as a discontinuous cut. In some embodiments, the cut in the second direction is continuous. In other words, the cut extends across the full width of the sheet if it is in the cross direction, or the cut extends along the full length of the sheet or is a continuous cutting operation if it is in the machine direction.

In some embodiments, the perforations of adjacent lines are offset from one another. The offset is achieved by positioning the perforations of one line so that they are not aligned with the perforations of the adjacent line when viewed orthogonally to the lines of perforations, i.e. in the second direction. The offset is therefore in the direction of the lines of perforations, i.e. the first direction. The perforations of adjacent lines may be partially offset but in some embodiments they are fully offset, or fully out of phase, so that the centre of a perforation of one line is aligned with the centre of a gap of the adjacent line, when viewed in the orthogonal direction to the direction of lines of perforations, i.e. the second direction.

In some embodiments, the perforations of adjacent lines are offset from one another and the perforations of alternate lines are not offset from one another, so they are aligned in the second direction.

In some embodiments, the perforations comprise a first group of alternate lines of perforations and a second group of alternate lines of perforations, wherein the perforations of the first group are aligned in the second direction, wherein the perforations of the second group are aligned in the second direction, and wherein the perforations of the second group are offset from the perforations of the first group in the first direction.

In some embodiments, the lines of perforations are equally spaced and the distance between alternate lines of perforations is the target length for the strips of material.

In some embodiments, each line of perforations comprises a sequence of alternating cuts and gaps. The cuts may be straight. In some embodiments, the length of each cut is greater than the length of each gap to provide an overlap between perforations of adjacent lines when viewed in the second direction. In some embodiments, all cuts are of substantially the same length and all gaps are of substantially the same length. All gaps and cuts can have the same length, but if the length of the cut is greater than the length of the gap, this provides an overlap between perforations of adjacent lines. When there is an overlap, some strips will be half the target length. Provided the majority of the strips are of the target length, it is acceptable to have a proportion of strips of half the target length. This avoids the risk of strips being formed which are longer than the target length, and which may be as long as the width of the sheet in extreme cases. In some embodiments, the proportion of strips which are less than the target length is 20% or less, 15% or less, 10% or less, 5% or less, 5-10%, 5-20%, 10-20% or 15-20%. The overlap, in relation to the length of the cut, may be about 20% or less, 15% or less, 10% or less, 5% or less, 5-10%, 5-20%, 10-20%, or 15-20%. The overlap may be about 5 mm or less, 4 mm or less, 3 mm or less, 2 mm or less, 1 mm or less, 5 mm-1 mm, 4 mm-1 mm, 3 mm-1 mm or 2 mm-1 mm.

In the embodiment where the first direction is the machine direction and the second direction is the cross direction (i.e. the lines of perforations are formed in the machine direction and the second cut is in the cross direction), the width of the sheet is preferably an integer multiple of the target length of the strips. For example, if the target length is 40 mm, the sheet width may be a multiple of 40 mm, so 200 mm, 240 mm, 280 mm, etc. which achieves the desired target length and a proportion with half the target length. The outermost lines of perforations can be located at a position which is half the target length in from the edges of the sheet.

In accordance with some embodiments, a method of shredding a plurality of sheets of material is provided, in which the sheets are individually perforated and subsequently brought together for cutting in the second direction to form strips of material.

Therefore, in relation to the methods described above, the sheet of material is a first sheet of material and the perforating step forms a first perforated sheet, the method further comprising the steps of: separately perforating a second sheet of material in a first direction with a plurality of parallel lines of perforations to form a second perforated sheet, wherein the perforations of adjacent lines are offset from one another; combining the first and second perforated sheets to form multiple layers of perforated sheets; and cutting the multiple layers of perforated sheets in a second direction to form individual strips of material.

In some embodiments, the sheets are perforated separately but simultaneously. For example, if the material is provided on a plurality of rolls, each roll may be perforated in a continuous process and the perforated webs fed together and combined before the cutting step is performed on the combined multiple webs.

In some embodiments, the number of sheets or webs which are individually perforated and subsequently combined for the cutting step is up to 15, 2-15, 2-10, 2-6 or 2-5.

In any of the embodiments described herein, the sheet of material may comprise a material selected from: aerosol-generating material, aerosol-former material, tobacco, paper reconstituted tobacco, amorphous solid, dried gel. The sheet of material may include menthol.

In accordance with some embodiments, apparatus for shredding a sheet of material is provided, the apparatus comprising: a perforator configured to perforate the sheet in a first direction with a plurality of parallel lines of perforations, wherein the perforations of adjacent lines are offset from one another; and a cutter configured to cut the perforated sheet in a second direction to form individual strips of material.

As discussed above, in some embodiments the first and second directions are orthogonal.

In some embodiments, the sheet of material is supplied in a machine direction. In general, the machine direction is the direction of travel of the material through the apparatus. The cross direction is orthogonal to the machine direction and is generally the direction across the apparatus. The machine direction may be referred to as the longitudinal direction and the cross direction referred to as the transverse direction.

In some embodiments, the first direction is the machine direction and the second direction is the cross direction. The lines of perforations are therefore formed in the machine direction and the second cut is in the cross direction.

In this embodiment, the perforator comprises a plurality of blades spaced in the cross direction with each blade extending in the machine direction to form the lines of perforations. A single blade may be employed to form each line of perforations, or multiple blades may be employed per line. Each blade may be rotatably mounted about an axis extending in the cross direction. Each blade may be mounted on a drum, cylinder, disc, etc.

In some embodiments, each line of perforations is formed by a plurality of blades arranged in a radial plane perpendicular to the axis of rotation. The plurality of blades to form each line of perforations may be provided on a disc. The number of blades forming each line of perforations may be 2-10, 2-8, 2-6, 2, 3, 4, 5, 6, 7, 8, 9 or 10. In one embodiment, five blades are provided on each disc. If the overlap between blades/perforations discussed above and below is fixed for any given number of blades, and the diameter of the disc is fixed, the higher the number of blades forming each line of perforations, will result in proportionally more overlap relative to the blade length. This will increase the proportion of strips which are half the target length.

In some embodiments, the apparatus further comprises a cleaning ring between each disc of blades which is configured to remove material from a blade when the blade is distal from the sheet. A suitable arrangement is disclosed in EP2078464. This document discloses a radially-movable cleaning ring provided between each pair of circular blades. The cleaning ring is moved radially by additional rollers. A shaft is provided with grooves to receive the blades where the cutting operation is required. At this point, the blades are exposed and extend into the grooves of the shaft. At another point distal from the cutting point, the cleaning ring is radially extended to cover the blades. This action not only protects the blades but also removes any material left on the blades from the cutting operation.

In some embodiments, adjacent blades in the axial or cross direction are offset from each other in the machine direction to form the offset lines of perforations. When the blades are provided on discs, the blades of adjacent discs are offset circumferentially. Alternate discs may have their blades in the same orientation. In one embodiment, two types of disc are provided, keyed to a shaft, one type setting the blades in a first position and the second type setting the blades in the offset position. Alternate discs will be of the same type. As discussed above, the cross direction distance between alternate discs is the target length of the strip.

In some embodiments, the apparatus comprises a first group of alternate discs and a second group of alternate discs, wherein the blades of the first group are aligned in the cross direction, wherein the blades of the second group are aligned in the cross direction, and wherein the blades of the second group are offset from the blades of the first group in the machine direction.

In some embodiments, each disc of blades comprises a sequence of alternating blades and gaps. The length of each blade may be greater than the length of each gap to provide an overlap between perforations of adjacent lines when viewed in the second direction, as discussed above.

In some embodiments, the blades have serrated teeth. The apparatus may be configured such that the blades move at a different speed from the sheet of material passing through the apparatus or such that the blades move at the same speed as the sheet.

In the embodiment where the second cut is in the cross direction, the cutter may comprise a blade configured to cut the sheet in the cross direction to form individual strips of material. The blade may be configured to cut the sheet continuously in the cross direction, i.e. a single, continuous cut as opposed to perforation.

In some embodiments, the cutter comprises a plurality of blades aligned in the cross direction which are rotatably mounted and spaced circumferentially. The blades may be mounted on a cylinder or drum. By changing the rotation speed and/or the number of blades and/or the speed of the sheet material, the width of the strips can be controlled. In some embodiments, it is desired to maintain the blade linear speed at a predetermined value, however the other parameters can be adjusted to adjust the width of the strips if desired.

In the embodiments described above, the first direction is the machine direction and the second direction is the cross direction. In other embodiments however, the first direction is the cross direction and the second direction is the machine direction. The lines of perforations are therefore formed in the cross direction and the second cut is in the machine direction. Further apparatus features for such embodiments are discussed below.

In such embodiments, the perforator may comprise a line of blades spaced in the cross direction with each blade extending in the cross direction to form a line of perforations across the sheet. The line of blades may be rotatably mounted about an axis extending in the cross direction. The line of blades may be provided on a cylinder. A plurality of lines of blades may be provided, each line being circumferentially spaced from the adjacent line and each forming a line of perforations.

Adjacent lines of blades may be offset from each other in the cross direction to form the offset perforations. Alternate lines may have their blades in the same cross direction position. In some embodiments, the distance in the machine direction between alternate lines is the target length of the strip.

In some embodiments, the apparatus comprises a first group of alternate lines of blades and a second group of alternate lines of blades, wherein the blades of the first group are aligned in the machine direction, wherein the blades of the second group are aligned in the machine direction, and wherein the blades of the second group are offset from the blades of the first group in the cross direction.

Each line of blades may comprise a sequence of alternating blades and gaps. The length of each blade may be greater than the length of each gap to provide an overlap between perforations of adjacent lines when viewed in the second direction. The function and properties of the overlap, including the ratio of overlap to length of cut and absolute overlap length, are as discussed above.

In such embodiments, the cutter may comprise a plurality of blades spaced in the cross direction and configured to cut the sheet in the machine direction to form individual strips of material. The blades may be configured to continuously cut the sheet in the machine direction. Each blade may be a rotary blade configured to continuously slit the sheet in the machine direction, such as a circular disc with a continuous blade formed around the circumference.

A method of shredding a plurality of sheets of material is discussed above, in which the sheets are individually perforated and subsequently brought together for cutting in the second direction to form strips of material. Apparatus to carry out such a method is also provided.

Therefore, in relation to the apparatus described above, the sheet of material is a first sheet of material and the perforator is a first perforator which forms a first perforated sheet, the apparatus further comprising: a second perforator configured to perforate a second sheet of material in a first direction with a plurality of parallel lines of perforations to form a second perforated sheet, wherein the perforations of adjacent lines are offset from one another, wherein the apparatus is configured to combine the first and second perforated sheets to form multiple layers of perforated sheets; and a cutter configured to cut the multiple layers of perforated sheets in a second direction to form individual strips of material.

In some embodiments, the first and second perforators perforate the sheets separately but simultaneously. For example, if the material is provided on a plurality of rolls, each roll may be perforated by a respective perforator in a continuous process and the perforated webs fed together and combined before the cutting step is performed on the combined perforated webs.

In some embodiments, the number of sheets or webs which are individually perforated and subsequently combined for the cutting step is up to 15, 2-15, 2-10, 2-6 or 2-5.

In some embodiments, the invention provides an article comprising strips of material formed by any of the methods or apparatus described herein. The article may be part of an aerosol provision system. The article may be a consumable article for use with a non-combustible aerosol provision system.

The strips of material in the article may comprise a proportion of strips having a first length and a proportion of strips having a second length which is less than the first length. The second length may be half the first length. The proportion of strips having the second length compared to the total number of strips may be 20% or less, 15% or less, 10% or less, 5% or less, 5-10%, 5-20%, 10-20% or 15-20%.

In some embodiments, the apparatus may operate at a machine speed of about 20-40 30 m/min, which is the speed of the sheet of material as it travels in the machine direction through the apparatus.

### BRIEF DESCRIPTION OF THE DRAWINGS

Embodiments will now be described, by way of example only, with reference to accompanying drawings, in which:

FIG. 1 shows a side-on cross sectional view of an article 1 for use in an aerosol delivery system;

FIG. 2 shows a schematic side view of an apparatus 100 for shredding a sheet of material;

FIG. 3 shows a schematic view of the operations carried out on a sheet 200 as it moves through the apparatus, in accordance with an embodiment;

FIG. 4 shows a schematic perspective view of a perforating section 400 suitable for perforating a sheet as shown in FIG. 3;

FIGS. 5A and 5B show cross-sectional views of a perforating section 400;

FIG. 6 shows a schematic perspective view of a cutting section 700 suitable for cutting a sheet as shown in FIG. 3;

FIG. 7 shows a schematic view of the operations carried out on a sheet 200′ as it moves through the apparatus in accordance with an alternative embodiment;

FIG. 8 shows a schematic perspective view of a perforating section 400′ suitable for perforating a sheet as shown in FIG. 7; and

FIG. 9 shows a schematic perspective view of a cutting section 700′ suitable for cutting a sheet as shown in FIG. 7.

### DETAILED DESCRIPTION

As used herein, the term “delivery system” is intended to encompass systems that deliver at least one substance to a user, and includes:
combustible aerosol provision systems, such as cigarettes, cigarillos, cigars, and tobacco for pipes or for roll-your-own or for make-your-own cigarettes (whether based on tobacco, tobacco derivatives, expanded tobacco, reconstituted tobacco, tobacco substitutes or other smokable material);
non-combustible aerosol provision systems that release compounds from an aerosol-generating material without combusting the aerosol-generating material, such as electronic cigarettes, tobacco heating products, and hybrid systems to generate aerosol using a combination of aerosol-generating materials; and
aerosol-free delivery systems that deliver the at least one substance to a user orally, nasally, transdermally or in another way without forming an aerosol, including but not limited to, lozenges, gums, patches, articles comprising inhalable powders, and oral products such as oral tobacco which includes snus or moist snuff, wherein the at least one substance may or may not comprise nicotine.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

The terms ‘upstream’ and ‘downstream’ used herein are relative terms defined in relation to the direction of mainstream aerosol drawn through an article or device in use.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energised so as to distribute power in the form of heat to an aerosol-generating material or to a heat transfer material in proximity to the exothermic power source.

In some embodiments, the non-combustible aerosol provision system comprises an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

In some embodiments, the consumable comprises a substance to be delivered. The substance to be delivered may be an aerosol-generating material or a material that is not intended to be aerosolized. As appropriate, either material may comprise one or more active constituents, one or more flavors, one or more aerosol-former materials, and/or one or more other functional materials.

In some embodiments, the substance to be delivered comprises an active substance.

The active substance as used herein may be a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical.

In some embodiments, the active substance comprises nicotine. In some embodiments, the active substance comprises caffeine, melatonin or vitamin B12.

As noted herein, the active substance may comprise or be derived from one or more botanicals or constituents, derivatives or extracts thereof. As used herein, the term “botanical” includes any material derived from plants including, but not limited to, extracts, leaves, bark, fibers, stems, roots, seeds, flowers, fruits, pollen, husk, shells or the like. Alternatively, the material may comprise an active compound naturally existing in a botanical, obtained synthetically. The material may be in the form of liquid, gas, solid, powder, dust, crushed particles, granules, pellets, shreds, strips, sheets, or the like. Example botanicals are tobacco, eucalyptus, star anise, hemp, cocoa, cannabis, fennel, lemongrass, peppermint, spearmint, rooibos, chamomile, flax, ginger, ginkgo biloba, hazel, hibiscus, laurel, licorice (liquorice), matcha, mate, orange skin, papaya, rose, sage, tea such as green tea or black tea, thyme, clove, cinnamon, coffee, aniseed (anise), basil, bay leaves, cardamom, coriander, cumin, nutmeg, oregano, paprika, rosemary, saffron, lavender, lemon peel, mint, juniper, elderflower, vanilla, wintergreen, beefsteak plant, curcuma, turmeric, sandalwood, cilantro, bergamot, orange blossom, myrtle, cassis, valerian, pimento, mace, damien, marjoram, olive, lemon balm, lemon basil, chive, carvi, verbena, tarragon, geranium, mulberry, ginseng, theanine, theacrine, maca, ashwagandha, damiana, guarana, chlorophyll, baobab or any combination thereof. The mint may be chosen from the following mint varieties: Mentha Arventis, Mentha c.v., Mentha niliaca, Mentha piperita, Mentha piperita citrata c.v., Mentha piperita c.v, Mentha spicata crispa, Mentha cardifolia, Mentha longifolia, Mentha suaveolens variegata, Mentha pulegium, Mentha spicata c.v. and Mentha suaveolens.

In some embodiments, the active substance comprises or is derived from one or more botanicals or constituents, derivatives or extracts thereof and the botanical is tobacco.

In some embodiments, the active substance comprises or derived from one or more botanicals or constituents, derivatives or extracts thereof and the botanical is selected from eucalyptus, star anise, cocoa and hemp.

In some embodiments, the active substance comprises or derived from one or more botanicals or constituents, derivatives or extracts thereof and the botanical is selected from rooibos and fennel.

In some embodiments, the substance to be delivered comprises a flavor.

As used herein, the terms “flavor” and “flavorant” refer to materials which, where local regulations permit, may be used to create a desired taste, aroma or other somatosensorial sensation in a product for adult consumers. They may include naturally occurring flavor materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, wintergreen, cherry, berry, red berry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene, thymol, camphene), flavor enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, liquid such as an oil, solid such as a powder, or gas.

In some embodiments, the flavor comprises menthol, spearmint and/or peppermint. In some embodiments, the flavor comprises flavor components of cucumber, blueberry, citrus fruits and/or redberry. In some embodiments, the flavor comprises eugenol. In some embodiments, the flavor comprises flavor components extracted from tobacco. In some embodiments, the flavor comprises flavor components extracted from cannabis.

In some embodiments, the flavor may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucolyptol, WS-3.

An aerosol-generating material is a material that is capable of generating aerosol, for example when heated, irradiated or energized in any other way. An aerosol-generating material may be in the form of a solid, liquid or gel which may or may not contain an active substance and/or flavorants. The aerosol-generating material may be incorporated into an article for use in the aerosol-generating system.

As used herein, the term “tobacco material” refers to any material comprising tobacco or derivatives or substitutes thereof. The tobacco material may be in any suitable form. The term “tobacco material” may include one or more of tobacco, tobacco derivatives, expanded tobacco, reconstituted tobacco or tobacco substitutes. The tobacco material may comprise one or more of ground tobacco, tobacco fiber, cut tobacco, extruded tobacco, tobacco stem, tobacco lamina, reconstituted tobacco and/or tobacco extract.

A consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

A susceptor is a material that is heatable by penetration with a varying magnetic field, such as an alternating magnetic field. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms. The device that is configured to generate the varying magnetic field is referred to as a magnetic field generator, herein.

An aerosol-modifying agent is a substance, typically located downstream of the aerosol generation area, that is configured to modify the aerosol generated, for example by changing the taste, flavor, acidity or another characteristic of the aerosol. The aerosol-modifying agent may be provided in an aerosol-modifying agent release component, that is operable to selectively release the aerosol-modifying agent

The aerosol-modifying agent may, for example, be an additive or a sorbent. The aerosol-modifying agent may, for example, comprise one or more of a flavorant, a colorant, water, and a carbon adsorbent. The aerosol-modifying agent may, for example, be a solid, a liquid, or a gel. The aerosol-modifying agent may be in powder, thread or granule form. The aerosol-modifying agent may be free from filtration material.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol. In some embodiments, the aerosol generator is configured to cause an aerosol to be generated from the aerosol-generating material without heating. For example, the aerosol generator may be configured to subject the aerosol-generating material to one or more of vibration, increased pressure, or electrostatic energy.

The filamentary tow material described herein can comprise cellulose acetate fiber tow. The filamentary tow can also be formed using other materials used to form fibers, such as polyvinyl alcohol (PVOH), polylactic acid (PLA), polycaprolactone (PCL), poly(1-4 butanediol succinate) (PBS), poly(butylene adipate-co-terephthalate) (PBAT), starch based materials, cotton, aliphatic polyester materials and polysaccharide polymers or a combination thereof. The filamentary tow may be plasticized with a suitable plasticizer for the tow, such as triacetin where the material is cellulose acetate tow, or the tow may be non-plasticized. The tow can have any suitable specification, such as fibers having a ‘Y’ shaped or other cross section such as ‘X’ shaped, filamentary denier values between 2.5 and 15 denier per filament, for example between 8.0 and 11.0 denier per filament and total denier values of 5,000 to 50,000, for example between 10,000 and 40,000.

In the figures described herein, like reference numerals are used to illustrate equivalent features, articles or components.

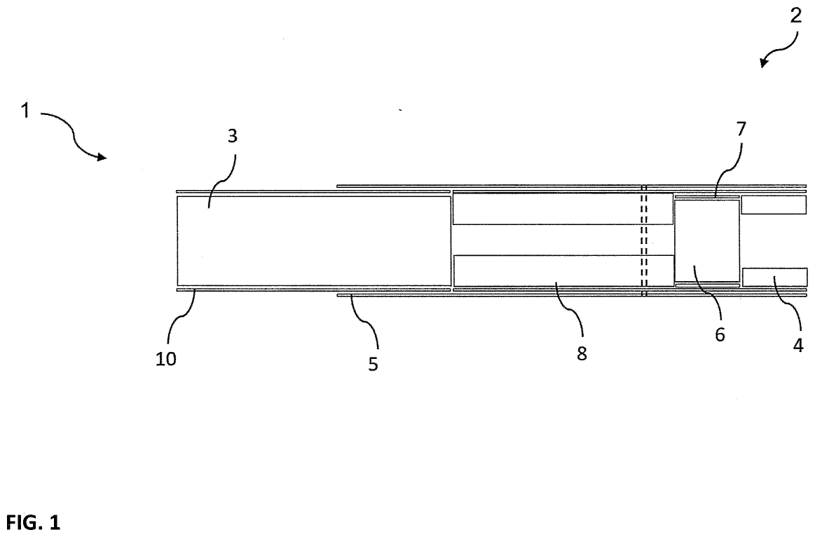

FIG. 1 is a side-on cross sectional view of an article 1 for use in an aerosol delivery system.

The article 1 comprises a mouthpiece 2, and an aerosol-generating section, connected to the mouthpiece 2. In the present example, the aerosol generating section comprises a source of aerosol-generating material in the form of a cylindrical rod of aerosol-generating material 3. In other examples, the aerosol-generating section may comprise a cavity for receiving a source of aerosol-generating material. The aerosol-generating material may comprise a plurality of strands or strips of aerosol-generating material. For example, the aerosol-generating material may comprise a plurality of strands or strips of an aerosolizable material and/or a plurality of strands or strips of an amorphous solid, as described hereinbelow. In some embodiments, the aerosol-generating material consists of a plurality of strands or strips of an aerosolizable material.

In the present example, the cylindrical rod of aerosol-generating material 3 comprises a plurality of strands and/or strips of aerosol-generating material, and is circumscribed by a wrapper 10. In the present example, the wrapper 10 is a moisture impermeable wrapper.

In the present example, the rod of aerosol-generating material 3 has a circumference of about 22.7 mm. In alternative embodiments, the rod of aerosol-generating material 3 may have any suitable circumference, for example between about 20 mm and about 26 mm.

The article 1 is configured for use in a non-combustible aerosol provision device comprising an aerosol generator for insertion into the aerosol generating section. In the present example, the aerosol generator is a heater, and the article is configured to receive the aerosol generator in the rod of aerosol-generating material.

The mouthpiece 2 includes a cooling section 8, also referred to as a cooling element, positioned immediately downstream of and adjacent to the source of aerosol-generating material 3. In the present example, the cooling section 8 is in an abutting relationship with the source of aerosol-generating material. The mouthpiece 2 also includes, in the present example, a body of material 6 downstream of the cooling section 8, and a hollow tubular element 4 downstream of the body of material 6, at the mouth end of the article 1.

The body of material 6 and hollow tubular element 4 each define a substantially cylindrical overall outer shape and share a common longitudinal axis. The body of material 6 is wrapped in a first plug wrap 7.

In the present example, the article 1 has an outer circumference of about 23 mm. In other examples, the article can be provided in any of the formats described herein, for instance having an outer circumference of between 20 mm and 26 mm. Since the article is to be heated to release an aerosol, improved heating efficiency can be achieved using articles having lower outer circumferences within this range, for instance circumferences of less than 23 mm. To achieve improved aerosol via heating, while maintaining a suitable product length, article circumferences of greater than 19 mm have also been found to be particularly effective. Articles having circumferences of between 20 mm and 24 mm, and more preferably between 20 mm and 23 mm, have been found to provide a good balance between providing effective aerosol delivery while allowing for efficient heating.

A tipping paper 5 is wrapped around the full length of the mouthpiece 2 and over part of the rod of aerosol-generating material 3 and has an adhesive on its inner surface to connect the mouthpiece 2 and rod 3. In the present example, the rod of aerosol-generating material 3 is wrapped in wrapper 10, which forms a first wrapping material, and the tipping paper 5 forms an outer wrapping material which extends at least partially over the rod of aerosol-generating material 3 to connect the mouthpiece 2 and rod 3. In some examples, the tipping paper can extend only partially over the rod of aerosol-generating material.

The aerosol-generating material comprises a shredded sheet of aerosolizable material. The aerosolizable material is arranged to generate aerosol when heated.

The shredded sheet may comprise one or more strands or strips of the aerosolizable material. In some embodiments, the shredded sheet comprises a plurality (e.g. two or more) strands or strips of the aerosolizable material. The strands or strips of aerosolizable material may have an aspect ratio of 1:1. In an embodiment, the strands or strips of aerosolizable material have an aspect ratio of greater than 1:1. In some embodiments, the strands or strips of aerosolizable material have an aspect ratio of from about 1:5 to about 1:16, or about 1:5, 1:6, 1:7, 1:8, 1:9, 1:10, 1:11 or 1:12. Where the aspect ratio of the strands or strips is greater than 1:1, the strands or strips comprises a longitudinal dimension, or length, extending between a first end of the strand or strip and a second end of the strand or strip.

Where the shredded sheet comprises a plurality of strands or strips of material, the dimensions of each strand or strip may vary between different strands or strips. For example, the shredded sheet may comprise a first population of strands or strips and a second population of strands or strips, wherein the dimensions of the strands or strips of the first population are different to the dimensions of the strands or strips of the second population. In other words, the plurality of strands or strips may comprise a first population of strands or strips having a first aspect ratio and a second population of strands or strips having a second aspect ratio that is different to the first aspect ratio.

A first dimension, or cut width, of the strands or strips of aerosolizable material may be between about 0.5 mm and 5 mm. However, when strands or strips of aerosolizable material having a cut width of below 0.9 mm are incorporated into an article for use in a non-combustible aerosol provision system, the pressure drop across the article may be increased to a level that renders the article unsuitable for use in a non-combustible aerosol-provision device. Also, if the strands or strips have a cut width greater than 2 mm, then it may be challenging to insert the strands or strips of aerosolizable material into the article during its manufacture. In a preferred embodiment, the cut width of the strands or strips of aerosolizable material is between about 1 mm and 1.5 mm.

The strands or strips of material are formed by shredding the sheet of aerosolizable material in accordance with the method described herein. The cut length of the shredded aerosolizable material is preferably at least 5 mm, for instance at least 10 mm, or at least 20 mm. The cut length of the shredded aerosolizable material can be less than 60 mm, less than 50 mm, or less than 40 mm.

In some embodiments, a plurality of strands or strips of aerosolizable material is provided and at least one of the plurality of strands or strips of aerosolizable material has a length greater than about 10 mm. At least one of the plurality of strands or strips of aerosolizable material can alternatively or in addition have a length between about 10 mm and about 60 mm, or between about 20 mm and about 50 mm. Each of the plurality of strands or strips of aerosolizable material can have a length between about 10 mm and about 60 mm, or between about 20 mm and about 50 mm.

The shredded sheet of aerosolizable material has a thickness of at least about 100 μm. The shredded sheet may have a thickness of at least about 120 μm, 140 μm, 160 μm, 180 μm or 200 μm. In some embodiments, the shredded sheet has a thickness of from about 150 μm to about 300 μm, from about 151 μm to about 299 μm, from about 152 μm to about 298 μm, from about 153 μm to about 297 μm, from about 154 μm to about 296 μm, from about 155 μm to about 295 μm, from about 156 μm to about 294 μm, from about 157 μm to about 293 μm, from about 158 μm to about 292 μm, from about 159 μm to about 291 μm or from about 160 μm to about 290 μm. In some embodiments, the shredded sheet has a thickness of from about 170 μm to about 280 μm, from about 180 to about 270 μm, from about 190 to about 260 μm, from about 200 μm to about 250 μm or from about 210 μm to about 240 μm.

The thickness of the shredded sheet may vary between the first and second surfaces. In some embodiments, an individual strip or piece of the aerosolizable material has a minimum thickness over its area of about 100 μm. In some cases, an individual strip or piece of the aerosolizable material has a minimum thickness over its area of about 0.05 mm or about 0.1 mm. In some cases, an individual strip, strand or piece of the aerosolizable material has a maximum thickness over its area of about 1.0 mm. In some cases, an individual strip or piece of the aerosolizable material has a maximum thickness over its area of about 0.5 mm or about 0.3 mm.

The thickness of the sheet can be determined using ISO 534:2011 “Paper and Board-Determination of Thickness”.

The shredded sheet of aerosol-generating material has an area density of from about 100 g/m² to about 250 g/m². The shredded sheet may have an area density of from about 110 g/m² to about 240 g/m², from about 120 g/m² to about 230 g/m², from about 130 g/m² to about 220 g/m² or from about 140 g/m² to about 210 g/m². In some embodiments, the shredded sheet has an area density of from about 130 g/m² to about 190 g/m², from about 140 g/m² to about 180 g/m², from about 150 g/m² to about 170 g/m². In a preferred embodiment, shredded sheet has an area density of about 160 g/m².

The average volume density of the shredded sheet of aerosol-generating material may be calculated from the thickness of the sheet and the area density of the sheet. The average volume density may be greater than about 0.2 g/cm³, about 0.3 g/cm³ or about 0.4 g/cm³.In some embodiments, the average volume density is from about 0.2 g/cm³ to about 1 g/cm³, from about 0.3 g/cm³ to about 0.9 g/cm³, from about 0.4 g/cm³ to about 0.9 g/cm³, from about 0.5 g/cm³ to about 0.9 g/cm³ or from about 0.6 g/cm³ to about 0.9 g/cm³.In some embodiments, the density is from about 0.4 g/cm³ to about 2.9 g/cm³, from about 0.4 g/cm³ to about 1 g/cm³, from about 0.6 g/cm³ to about 1.6 g/cm³ or from about 1.6 g/cm³ to about 2.9 g/cm³.

The shredded sheet may have a tensile strength of at least 4 N/15 mm. Where the shredded sheet has a tensile strength below 4 N/15 mm, the shredded sheet is likely to tear, break or otherwise deform during its manufacture and/or subsequent incorporation into an article for use in a non-combustible aerosol provision system. Tensile strength may be measured using ISO 1924:2008.

The aerosol-generating material may comprise tobacco material. The shredded sheet of aerosolizable material may comprise tobacco material.

The tobacco material may be a particulate or granular material. In some embodiments, the tobacco material is a powder. Alternatively or in addition, the tobacco material may comprise may comprise strips, strands or fibers of tobacco. For example, the tobacco material may comprise particles, granules, fibers, strips and/or strands of tobacco. In some embodiments, the tobacco material consists of particles or granules of tobacco material.

The density of the tobacco material has an impact on the speed at which heat conducts through the material, with lower densities, for instance those below 900 mg/cc, conducting heat more slowly through the material, and therefore enabling a more sustained release of aerosol.

The tobacco material can comprise reconstituted tobacco material having a density of less than about 900 mg/cc, for instance paper reconstituted tobacco material. For instance, the aerosol-generating material comprises reconstituted tobacco material having a density of less than about 800 mg/cc. Alternatively or in addition, the aerosol-generating material can comprise reconstituted tobacco material having a density of at least 350 mg/cc.

The reconstituted tobacco material can be provided in the form of a shredded sheet. The sheet of reconstituted tobacco material may have any suitable thickness. The reconstituted tobacco material may have a thickness of at least about 0.145 mm, for instance at least about 0.15 mm, or at least about 0.16 mm. The reconstituted tobacco material may have a maximum thickness of about 0.30 mm or 0.25 mm, for instance the thickness of the reconstituted tobacco material may be less than about 0.22 mm, or less than about 0.2 mm. In some embodiments, the reconstituted tobacco material may have an average thickness in the range 0.175 mm to 0.195 mm.

In some embodiments, the tobacco is a particulate tobacco material. Each particle of the particulate tobacco material may have a maximum dimension. As used herein, the term “maximum dimension” refers to the longest straight line distance from any point on the surface of a particle of tobacco, or on a particle surface, to any other surface point on the same particle of tobacco, or particle surface. The maximum dimension of a particle of particulate tobacco material may be measured using scanning electron microscopy (SEM).

The maximum dimension of each particle of tobacco material can be up to about 200 μm. In some embodiments, the maximum dimension of each particle of tobacco material is up to about 150 μm.

A population of particles of the tobacco material may have a particle size distribution (D90) of at least about 100 μm. In some embodiments, a population of particles of the tobacco material has a particle size distribution (D90) of about 110 μm, at least about 120 μm, at least about 130 μm, at least about 140 μm or at least about 150 μm. In an embodiment, a population of particles of the tobacco material has a particle size distribution (D90) of about 150 μm. Sieve analysis can also be used to determine the particle size distribution of the particles of tobacco material.

A particle size distribution (D90) of at least about 100 μm is thought to contribute to the tensile strength of the shredded sheet of aerosolizable material.

A particle size distribution (D90) of less than 100 μm provides a shredded sheet of aerosolizable material having good tensile strength. However, the inclusion of such fine particles of tobacco material in the shredded sheet can increase its density. When the shredded sheet is incorporated into an article for use in a non-combustible aerosol provision system, this higher density may decrease the fill-value of the tobacco material. Advantageously, a balance between a satisfactory tensile strength and suitable density (and thus fill-value) may be achieved where the particle size distribution (D90) is at least about 100 μm.

The particle size of the particulate tobacco material can also influence the roughness of the shredded sheet of aerosol generating material. It is postulated that forming the shredded sheet of aerosol-generating material by incorporating relatively large particles of tobacco material decreases the density of the shredded sheet of aerosol generating material.

The tobacco material may comprise tobacco obtained from any part of the tobacco plant. In some embodiments, the tobacco material comprises tobacco leaf.

The shredded sheet can comprise from 5% to about 90% by weight tobacco leaf.

The tobacco material may comprise lamina tobacco and/or tobacco stem, such as midrib stem. The lamina tobacco can be present in an amount of from 0% to about 100%, from about 20% to about 100%, from about 40% to about 100%, from about 40% to about 95%, from about 45% to about 90%, from about 50% to about 85% or from about 55% to about 80% by weight of the shredded sheet and/or tobacco material. In some embodiments, tobacco material consists or consists essentially of lamina tobacco material.

The tobacco material may comprise tobacco stem in an amount of from 0% to about 100%, from about 0% to about 50%, from about 0 to about 25%, from about 0 to about 20%, from about 5 to about 15% by weight of the shredded sheet.

In some embodiments, the tobacco material comprises a combination of lamina and tobacco stem. In some embodiments, the tobacco material can comprise lamina in an amount of from about 40% to about 95% and stem in an amount of from about 5% to about 60%, or lamina in an amount of from about 60% to about 95% and stem in an amount of from about 5% to about 40%, or lamina in an amount of from about 80% to about 95% and stem in an amount of from about 5% to about 20% by weight of the shredded sheet of aerosolizable material.

The incorporation of stem may decrease the tackiness of the aerosolizable material. Incorporating tobacco material comprising stem tobacco into the aerosolizable material may increase its burst strength.

The shredded sheet of aerosolizable material may have a burst strength of at least about 75 g, at least about 100 g or at least about 200 g.

If the burst strength is too low the shredded sheet may be relatively brittle. As a consequence, breakages in the shredded sheet may occur during the process of manufacturing the aerosolizable material. For example, when the sheet is shredded to form a shredded sheet by a cutting process, the sheet may shatter or break into pieces or shards when cut.

The tobacco material described herein may contain nicotine. The nicotine content is from 0.1 to 3% by weight of the tobacco material, and may be, for example, from 0.5 to 2.5% by weight of the tobacco material. Additionally or alternatively, the tobacco material contains between 10% and 90% by weight tobacco leaf having a nicotine content of greater than about 1% or about 1.5% by weight of the tobacco leaf. The tobacco leaf, for instance cut rag tobacco, can, for instance, have a nicotine content of between 1% and 5% by weight of the tobacco leaf.

The shredded sheet of aerosolizable material may comprise nicotine in an amount of between about 0.1% to about 3% by weight of the shredded sheet.

Paper reconstituted tobacco may also be present in the aerosol-generating material described herein. Paper reconstituted tobacco refers to tobacco material formed by a process in which tobacco feedstock is extracted with a solvent to afford an extract of solubles and a residue comprising fibrous material, and then the extract (usually after concentration, and optionally after further processing) is recombined with fibrous material from the residue (usually after refining of the fibrous material, and optionally with the addition of a portion of non-tobacco fibers) by deposition of the extract onto the fibrous material. The process of recombination resembles the process for making paper.

The paper reconstituted tobacco may be any type of paper reconstituted tobacco that is known in the art. In a particular embodiment, the paper reconstituted tobacco is made from a feedstock comprising one or more of tobacco strips, tobacco stems, and whole leaf tobacco. In a further embodiment, the paper reconstituted tobacco is made from a feedstock consisting of tobacco strips and/or whole leaf tobacco, and tobacco stems. However, in other embodiments, scraps, fines and winnowings can alternatively or additionally be employed in the feedstock.

The paper reconstituted tobacco for use in the tobacco material described herein may be prepared by methods which are known to those skilled in the art for preparing paper reconstituted tobacco.

In embodiments, the paper reconstituted tobacco is present in an amount of from 5% to 90% by weight, 10% to 80% by weight, or 20% to 70% by weight, of the aerosol-generating material.

The aerosol-generating material may comprise an aerosol-former material. The aerosol-former material comprises one or more constituents capable of forming an aerosol. The aerosol-former material may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate. Preferably, the aerosol-former material is glycerol or propylene glycol.

The aerosol-former material may be provided in an amount of up to about 50% on a dry weight base by weight of the shredded sheet. In some embodiments, the aerosol former material is provided in an amount of from about 5% to about 40% on a dry weight base by weight of the shredded sheet, from about 10% to about 30% on a dry weight base by weight of the shredded from about 10% to about 20% on a dry weight base by weight of the shredded sheet.

The shredded sheet may also comprise water. The shredded sheet of aerosolizable material may comprise water in an amount of less than about 15%, less than about 10% or less than about 5% by weight of the aerosolizable material. In some embodiments, the aerosolizable material comprises water in an amount of between about 0% and about 15% or between about 5% and about 15% by weight of the aerosolizable material.

The shredded sheet of aerosolizable material may comprise water and an aerosol-former material, in a total amount, of less than about 30% by weight of the shredded sheet of aerosolizable material or less than about 25% by weight of the shredded sheet of aerosolizable material. It is thought that incorporating water and aerosol-former material in the shredded sheet of aerosolizable material in an amount of less than about 30% by weight of the shredded sheet of aerosolizable material may advantageously reduce the tackiness of the sheet. This may improve the ease by which the aerosolizable material can be handled during processing. For example, it may be easier to roll a sheet of aerosolizable material to form a bobbin of material and then unroll the bobbin without the layers of sheet sticking together. Reducing the tackiness may also decrease the propensity for strands or strips of shredded material to clump or stick together, thus further improving processing efficiency and the quality of the final product.

The shredded sheet may comprise a binder. The binder is arranged to bind the components of the aerosol-generating material to form the shredded sheet. The binder may at least partially coat the surface of the tobacco material. Where the tobacco material is in a particulate form, the binder may at least partially coat the surface of the particles of tobacco and bind them together.

The binder may be selected from one or more compounds selected from the group comprising alginates, pectins, starches (and derivatives), celluloses (and derivatives), gums, silica or silicones compounds, clays, polyvinyl alcohol and combinations thereof. For example, in some embodiments, the binder comprises one or more of alginates, pectins, hydroxyethyl cellulose, hydroxypropyl cellulose, carboxymethylcellulose, pullulan, xanthan gum, guar gum, carrageenan, agarose, acacia gum, fumed silica, PDMS, sodium silicate, kaolin and polyvinyl alcohol. In some cases, the binder comprises alginate and/or pectin or carrageenan. In a preferred embodiment, the binder comprises guar gum.

The binder may be present in an amount of from about 1 to about 20% by weight of the shredded sheet, or in an amount of from 1 to about 10% by weight of the shredded sheet of aerosolizable material. For example, the binder may be present in an amount of about 1%, 2%, 3%, 4%, 5%, 6%, 7%, 8%, 9% or 10% by weight of the shredded sheet of aerosolizable material.

The aerosol-generating material may comprise a filler. In some embodiments, the shredded sheet comprises the filler. The filler is generally a non-tobacco component, that is, a component that does not include ingredients originating from tobacco. The filler may comprise one or more inorganic filler materials, such as calcium carbonate, perlite, vermiculite, diatomaceous earth, colloidal silica, magnesium oxide, magnesium sulphate, magnesium carbonate, and suitable inorganic sorbents, such as molecular sieves. The filler may be a non-tobacco fiber such as wood fiber or pulp or wheat fiber. The filler can be a material comprising cellulose or a material comprises a derivate of cellulose. The filler component may also be a non-tobacco cast material or a non-tobacco extruded material.

In particular embodiments which include filler, the filler is fibrous. For example, the filler may be a fibrous organic filler material such as wood, wood pulp, hemp fiber, cellulose or cellulose derivatives. Without wishing to be bound by theory, it is believed that including fibrous filler may increase the tensile strength of the material.

The filler may also contribute to the texture of the shredded sheet of the aerosolizable material. For example, a fibrous filler, such as wood or wood pulp, may provide a shredded sheet of aerosolizable material having relatively rough first and second surfaces. Conversely, a non-fibrous, particulate filler, such as powdered chalk, may provide a shredded sheet of aerosolizable material having relatively smooth first and second surfaces. In some embodiments, the aerosolizable material comprises a combination of different filler materials.

The filler component may be present in an amount of 0 to 20% by weight of the shredded sheet, or in an amount of from 1 to 10% by weight of the shredded sheet. In some embodiments, the filler component is absent.

The filler may help to improve the general structural properties of the aerosolizable material, such as its tensile strength and burst strength.

In the compositions described herein, where amounts are given in % by weight, for the avoidance of doubt this refers to a dry weight basis, unless specifically indicated to the contrary. Thus, any water that may be present in the aerosol-generating material, or in any component thereof, is entirely disregarded for the purposes of the determination of the weight %. The water content of the aerosol-generating material described herein may vary and may be, for example, from 5 to 15% by weight. The water content of the aerosol-generating material described herein may vary according to, for example, the temperature, pressure and humidity conditions at which the compositions are maintained. The water content can be determined by Karl-Fisher analysis, as known to those skilled in the art. On the other hand, for the avoidance of doubt, even when the aerosol-former material is a component that is in liquid phase, such as glycerol or propylene glycol, any component other than water is included in the weight of the aerosol-generating material. However, when the aerosol-former material is provided in the tobacco component of the aerosol-generating material, or in the filler component (if present) of the aerosol-generating material, instead of or in addition to being added separately to the aerosol-generating material, the aerosol-former material is not included in the weight of the tobacco component or filler component, but is included in the weight of the “aerosol-former material” in the weight % as defined herein. All other ingredients present in the tobacco component are included in the weight of the tobacco component, even if of non-tobacco origin (for example non-tobacco fibers in the case of paper reconstituted tobacco).

The aerosol-generating material herein can comprise an aerosol modifying agent, such as any of the flavors described herein. In one embodiment, the aerosol-generating material comprises menthol. When the aerosol-generating material is incorporated into an article for use in an aerosol-provision system, the article may be referred to as a mentholated article. The aerosol-generating material can comprise from 0.5 mg to 20 mg of menthol, from 0.7 mg to 20 mg of menthol, between 1 mg and 18 mg or between 8 mg and 16 mg of menthol. In the present example, the aerosol-generating material comprises 16 mg of menthol. The aerosol-generating material can comprise between 1% and 8% by weight of menthol, preferably between 3% and 7% by weight of menthol and more preferably between 4% and 5.5% by weight of menthol. In one embodiment, the aerosol-generating material comprises 4.7% by weight of menthol. Such high levels of menthol loading can be achieved using a high percentage of reconstituted tobacco material, for instance greater than 50% of the tobacco material by weight. Alternatively or additionally, the use of a high volume of, for instance tobacco material, can increase the level of menthol loading that can be achieved, for instance where greater than about 500 mm³ or suitably more than about 1000 mm³ of aerosol-generating material, such as tobacco material, are used.

In some embodiments, the composition comprises an aerosol-forming “amorphous solid”, which may alternatively be referred to as a “monolithic solid” (i.e. non-fibrous). In some embodiments, the amorphous solid may comprise a dried gel. The amorphous solid is a solid material that may retain some fluid, such as liquid, within it.

In some examples, the amorphous solid comprises:
1-60 wt % of a gelling agent;
0.1-50 wt % of an aerosol-former material; and
0.1-80 wt % of a flavor;

wherein these weights are calculated on a dry weight basis.

In some further embodiments, the amorphous solid comprises:
1-50 wt % of a gelling agent;
0.1-50 wt % of an aerosol-former material; and
30-60 wt % of a flavor;

wherein these weights are calculated on a dry weight basis.

The amorphous solid material may be provided in in shredded sheet form. The amorphous solid material may take the same form as the shredded sheet of aerosolizable material described previously.

Suitably, the amorphous solid may comprise from about 1 wt %, 5 wt %, 10 wt %, 15 wt %, 20 wt % or 25 wt % to about 60 wt %, 50 wt %, 45 wt %, 40 wt % or 35 wt % of a gelling agent (all calculated on a dry weight basis). For example, the amorphous solid may comprise 1-50 wt %, 5-45 wt %, 10-40 wt % or 20-35 wt % of a gelling agent. In some embodiments, the gelling agent comprises a hydrocolloid. In some embodiments, the gelling agent comprises one or more compounds selected from the group comprising alginates, pectins, starches (and derivatives), celluloses (and derivatives), gums, silica or silicones compounds, clays, polyvinyl alcohol and combinations thereof. For example, in some embodiments, the gelling agent comprises one or more of alginates, pectins, hydroxyethyl cellulose, hydroxypropyl cellulose, carboxymethylcellulose, pullulan, xanthan gum guar gum, carrageenan, agarose, acacia gum, fumed silica, PDMS, sodium silicate, kaolin and polyvinyl alcohol. In some cases, the gelling agent comprises alginate and/or pectin, and may be combined with a setting agent (such as a calcium source) during formation of the amorphous solid. In some cases, the amorphous solid may comprise a calcium-crosslinked alginate and/or a calcium-crosslinked pectin.

In some embodiments, the gelling agent comprises alginate, and the alginate is present in the amorphous solid in an amount of from 10-30 wt % of the amorphous solid (calculated on a dry weight basis). In some embodiments, alginate is the only gelling agent present in the amorphous solid. In other embodiments, the gelling agent comprises alginate and at least one further gelling agent, such as pectin.

In some embodiments the amorphous solid may include gelling agent comprising carrageenan.

Suitably, the amorphous solid may comprise from about 0.1 wt %, 0.5 wt %, 1 wt %, 3 wt %, 5 wt %, 7 wt % or 10% to about 50 wt %, 45 wt %, 40 wt %, 35 wt %, 30 wt % or 25 wt % of an aerosol-former material (all calculated on a dry weight basis). The aerosol-former material may act as a plasticizer. For example, the amorphous solid may comprise 0.5-40 wt %, 3-35 wt % or 10-25 wt % of an aerosol-former material. In some cases, the aerosol-former material comprises one or more compound selected from erythritol, propylene glycol, glycerol, triacetin, sorbitol and xylitol. In some cases, the aerosol-former material comprises, consists essentially of or consists of glycerol.

The amorphous solid comprises a flavor. Suitably, the amorphous solid may comprise up to about 80 wt %, 70 wt %, 60 wt %, 55 wt %, 50 wt % or 45 wt % of a flavor.

In some cases, the amorphous solid may comprise at least about 0.1 wt %, 1 wt %, 10 wt %, 20 wt %, 30 wt %, 35 wt % or 40 wt % of a flavor (all calculated on a dry weight basis).

For example, the amorphous solid may comprise 1-80 wt %, 10-80 wt %, 20-70 wt %, 30-60 wt %, 35-55 wt % or 30-45 wt % of a flavor. In some cases, the flavor comprises, consists essentially of or consists of menthol.

In some cases, the amorphous solid may additionally comprise an emulsifying agent, which emulsified molten flavor during manufacture. For example, the amorphous solid may comprise from about 5 wt % to about 15 wt % of an emulsifying agent (calculated on a dry weight basis), suitably about 10 wt %. The emulsifying agent may comprise acacia gum.

In some embodiments, the amorphous solid is a hydrogel and comprises less than about 20 wt % of water calculated on a wet weight basis. In some cases, the hydrogel may comprise less than about 15 wt %, 12 wt % or 10 wt % of water calculated on a wet weight basis. In some cases, the hydrogel may comprise at least about 1 wt %, 2 wt % or at least about 5 wt % of water (WWB).

In some embodiments, the amorphous solid additionally comprises an active substance. For example, in some cases, the amorphous solid additionally comprises a tobacco material and/or nicotine. In some cases, the amorphous solid may comprise 5-60 wt % (calculated on a dry weight basis) of a tobacco material and/or nicotine. In some cases, the amorphous solid may comprise from about 1 wt %, 5 wt %, 10 wt %, 15 wt %, 20 wt % or 25 wt % to about 70 wt %, 60 wt %, 50 wt %, 45 wt %, 40 wt %, 35 wt %, or 30 wt % (calculated on a dry weight basis) of an active substance. In some cases, the amorphous solid may comprise from about 1 wt %, 5 wt %, 10 wt %, 15 wt %, 20 wt % or 25 wt % to about 70 wt %, 60 wt %, 50 wt %, 45 wt %, 40 wt %, 35 wt %, or 30 wt % (calculated on a dry weight basis) of a tobacco material. For example, the amorphous solid may comprise 10-50 wt %, 15-40 wt % or 20-35 wt % of a tobacco material. In some cases, the amorphous solid may comprise from about 1 wt %, 2 wt %, 3 wt % or 4 wt % to about 20 wt %, 18 wt %, 15 wt % or 12 wt % (calculated on a dry weight basis) of nicotine. For example, the amorphous solid may comprise 1-20 wt %, 2-18 wt % or 3-12 wt % of nicotine.

In some cases, the amorphous solid comprises an active substance such as tobacco extract. In some cases, the amorphous solid may comprise 5-60 wt % (calculated on a dry weight basis) of tobacco extract. In some cases, the amorphous solid may comprise from about 5 wt %, 10 wt %, 15 wt %, 20 wt % or 25 wt % to about 60 wt %, 50 wt %, 45 wt %, 40 wt %, 35 wt %, or 30 wt % (calculated on a dry weight basis) tobacco extract. For example, the amorphous solid may comprise 10-50 wt %, 15-40 wt % or 20-35 wt % of tobacco extract. The tobacco extract may contain nicotine at a concentration such that the amorphous solid comprises 1 wt % 1.5 wt %, 2 wt % or 2.5 wt % to about 6 wt %, 5 wt %, 4.5 wt % or 4 wt % (calculated on a dry weight basis) of nicotine.

In some cases, there may be no nicotine in the amorphous solid other than that which results from the tobacco extract.

In some embodiments the amorphous solid comprises no tobacco material but does comprise nicotine. In some such cases, the amorphous solid may comprise from about 1 wt %, 2 wt %, 3 wt % or 4 wt % to about 20 wt %, 18 wt %, 15 wt % or 12 wt % (calculated on a dry weight basis) of nicotine. For example, the amorphous solid may comprise 1-20 wt %, 2-18 wt % or 3-12 wt % of nicotine.

In some cases, the total content of active substance and/or flavor may be at least about 0.1 wt %, 1 wt %, 5 wt %, 10 wt %, 20 wt %, 25 wt % or 30 wt %. In some cases, the total content of active substance and/or flavor may be less than about 90 wt %, 80 wt %, 70 wt %, 60 wt %, 50 wt % or 40 wt % (all calculated on a dry weight basis).

In some cases, the total content of tobacco material, nicotine and flavor may be at least about 0.1 wt %, 1 wt %, 5 wt %, 10 wt %, 20 wt %, 25 wt % or 30 wt %. In some cases, the total content of active substance and/or flavor may be less than about 90 wt %, 80 wt %, 70 wt %, 60 wt %, 50 wt % or 40 wt % (all calculated on a dry weight basis).

The amorphous solid may be made from a gel, and this gel may additionally comprise a solvent, included at 0.1-50 wt %. However, the inclusion of a solvent in which the flavor is soluble may reduce the gel stability and the flavor may crystallise out of the gel. As such, in some cases, the gel does not include a solvent in which the flavor is soluble.

In some embodiments, the amorphous solid comprises less than 60 wt % of a filler, such as from 1 wt % to 60 wt %, or 5 wt % to 50 wt %, or 5 wt % to 30 wt %, or 10 wt % to 20 wt %.

In other embodiments, the amorphous solid comprises less than 20 wt %, suitably less than 10 wt % or less than 5 wt % of a filler. In some cases, the amorphous solid comprises less than 1 wt % of a filler, and in some cases, comprises no filler.

The filler, if present, may comprise one or more inorganic filler materials, such as calcium carbonate, perlite, vermiculite, diatomaceous earth, colloidal silica, magnesium oxide, magnesium sulphate, magnesium carbonate, and suitable inorganic sorbents, such as molecular sieves. The filler may comprise one or more organic filler materials such as wood pulp, cellulose and cellulose derivatives. In particular cases, the amorphous solid comprises no calcium carbonate such as chalk.

In particular embodiments which include filler, the filler is fibrous. For example, the filler may be a fibrous organic filler material such as wood pulp, hemp fiber, cellulose or cellulose derivatives. Without wishing to be bound by theory, it is believed that including fibrous filler in an amorphous solid may increase the tensile strength of the material.

In some embodiments, the amorphous solid does not comprise tobacco fibers.

In some examples, the amorphous solid in sheet form may have a tensile strength of from around 200 N/m to around 1500 N/m. In some examples, such as where the amorphous solid does not comprise a filler, the amorphous solid may have a tensile strength of from 200 N/m to 400 N/m, or 200 N/m to 300 N/m, or about 250 N/m. Such tensile strengths may be particularly suitable for embodiments wherein the amorphous solid material is formed as a sheet and then shredded and incorporated into an aerosol-generating article.

In some examples, such as where the amorphous solid comprises a filler, the amorphous solid may have a tensile strength of from 600 N/m to 1500 N/m, or from 700 N/m to 900 N/m, or around 800 N/m. Such tensile strengths may be particularly suitable for embodiments wherein the amorphous solid material is included in an aerosol-generating article as a rolled sheet, suitably in the form of a tube.

In some cases, the amorphous solid may consist essentially of, or consist of a gelling agent, water, an aerosol-former material, a flavor, and optionally an active substance.

In some cases, the amorphous solid may consist essentially of, or consist of a gelling agent, water, an aerosol-former material, a flavor, and optionally a tobacco material and/or a nicotine source.

The amorphous solid may comprise one or more active substances and/or flavors, one or more aerosol-former materials, and optionally one or more other functional material.

The aerosol-generating material can comprise a paper reconstituted tobacco material. The composition can alternatively or additionally comprise any of the forms of tobacco described herein. The aerosol generating material can comprise a shredded sheet comprising tobacco material comprising between 10% and 90% by weight tobacco leaf, wherein an aerosol-former material is provided in an amount of up to about 20% by weight of the shredded sheet, and the remainder of the tobacco material comprises paper reconstituted tobacco.

Where the aerosol-generating material comprises an amorphous solid material, the amorphous solid material may be a dried gel comprising menthol. In alternative embodiments, the amorphous solid may have any composition as described herein.

An improved article may be produced comprising aerosol-generating material comprising a first component comprising a shredded sheet of aerosolizable material and a second component comprising amorphous solid, wherein the material properties (e.g. density) and specification (e.g. thickness, length, and cut width) fall within the ranges set out herein.

In some cases, the amorphous solid may have a thickness of about 0.015 mm to about 1.0 mm. Suitably, the thickness may be in the range of about 0.05 mm, 0.1 mm or 0.15 mm to about 0.5 mm or 0.3 mm. A material having a thickness of about 0.09 mm can be used. The amorphous solid may comprise more than one layer, and the thickness described herein refers to the aggregate thickness of those layers.

The thickness of the amorphous solid material may be measured using a calliper or a microscope such as a scanning electron microscope (SEM), as known to those skilled in the art, or any other suitable technique known to those skilled in the art.

If the amorphous solid is too thick, then heating efficiency can be compromised. This can adversely affect power consumption in use, for instance the power consumption for release of flavor from the amorphous solid. Conversely, if the aerosol-forming amorphous solid is too thin, it can be difficult to manufacture and handle; a very thin material can be harder to cast and may be fragile, compromising aerosol formation in use. In some cases, an individual strip or piece of the amorphous solid has a minimum thickness over its area of about 0.015. In some cases, an individual strip or piece of the amorphous solid has a minimum thickness over its area of about 0.05 mm or about 0.1 mm. In some cases, an individual strip or piece of the amorphous solid has a maximum thickness over its area of about 1.0 mm. In some cases, an individual strip or piece of the amorphous solid has a maximum thickness over its area of about 0.5 mm or about 0.3 mm.

In some cases, the amorphous solid thickness may vary by no more than 25%, 20%, 15%, 10%, 5% or 1% across its area.

Providing amorphous solid material and shredded sheet of aerosolizable material having area density values that differ from each other by less than a given percentage results in less separation in a mixture of these materials. In some examples, the area density of the amorphous solid material may be between 50% and 150% of the area density of the aerosolizable material. For instance, the area density of the amorphous solid material may be between 60% and 140% of the density of the aerosolizable material, or between 70% and 110% of the area density of the aerosolizable material, or between 80% and 120% of the area density of the aerosolizable material.

In embodiments described herein, the amorphous solid material may be incorporated into the article in sheet form. The amorphous solid material in sheet form may be shredded and then incorporated into the article, suitably mixed into with an aerosolizable material, such as the shredded sheet of aerosolizable material described herein.

In further embodiments the amorphous solid sheet may additionally be incorporated as a planar sheet, as a gathered or bunched sheet, as a crimped sheet, or as a rolled sheet (i.e. in the form of a tube). In some such cases, the amorphous solid of these embodiments may be included in an aerosol-generating article as a sheet, such as a sheet circumscribing a rod comprising aerosolizable material. For example, the amorphous solid sheet may be formed on a wrapping paper which circumscribes an aerosolizable material such as tobacco.

The amorphous solid in sheet form may have any suitable area density, such as from about 30 g/m² to about 150 g/m². In some cases, the sheet may have a mass per unit area of about 55 g/m² to about 135 g/m², or about 80 to about 120 g/m², or from about 70 to about 110 g/m², or particularly from about 90 to about 110 g/m², or suitably about 100 g/m². These ranges can provide a density which is similar to the density of cut rag tobacco and as a result a mixture of these substances can be provided which will not readily separate. Such area densities may be particularly suitable where the amorphous solid material is included in an aerosol-generating article as a shredded sheet (described further hereinbelow). In some cases, the sheet may have a mass per unit area of about 30 to 70 g/m², 40 to 60 g/m², or 25 to 60 g/m² and may be used to wrap an aerosolizable material, such as the aerosolizable material described herein.

The aerosol-generating material may comprise a blend of the aerosolizable material and the amorphous solid material as described herein. Such aerosol-generating material can provide an aerosol, in use, with a desirable flavor profile, since additional flavor may be introduced to the aerosol-generating material by inclusion in the amorphous solid material component. Flavor provided in the amorphous solid material may be more stably retained within the amorphous solid material compared to flavor added directly to the tobacco material, resulting in a more consistent flavor profile between articles produced according to this disclosure.

As described above, tobacco material having a density of at least 350 mg/cc and less than about 900 mg/cc, preferably between about 600 mg/cc and about 900 mg/cc, has been advantageously found to result in a more sustained release of aerosol. To provide an aerosol having a consistent flavor profile the amorphous solid material component of the aerosol-generating material should be evenly distributed throughout the rod. This can be achieved by casting the amorphous solid material to have a thickness as described herein, to provide an amorphous solid material having an area density which is similar to the area density of the tobacco material, and processing the amorphous solid material as described hereinbelow to ensure an even distribution throughout the aerosol-generating material.

As noted above, optionally, the aerosol-generating material comprises a plurality of strips of amorphous solid material. Where the aerosol generating section comprises a plurality of strands and/or strips of the sheet of aerosolizable material and a plurality of strips of amorphous solid material, the material properties and/or dimensions of the at least two components may be suitably selected in other ways, to ensure a relatively uniform mix of the components is possible, and to reduce separation or un-mixing of the components during or after manufacture of the rod of aerosol-generating material.

The longitudinal dimension of the plurality of strands or strips may be substantially the same as a length of the aerosol generating section. The plurality of strands and/or strips may have a length of at least about 5 mm.

A method and apparatus for shredding a sheet of material, which may be used as a shredded aerosol generating material, will now be described.

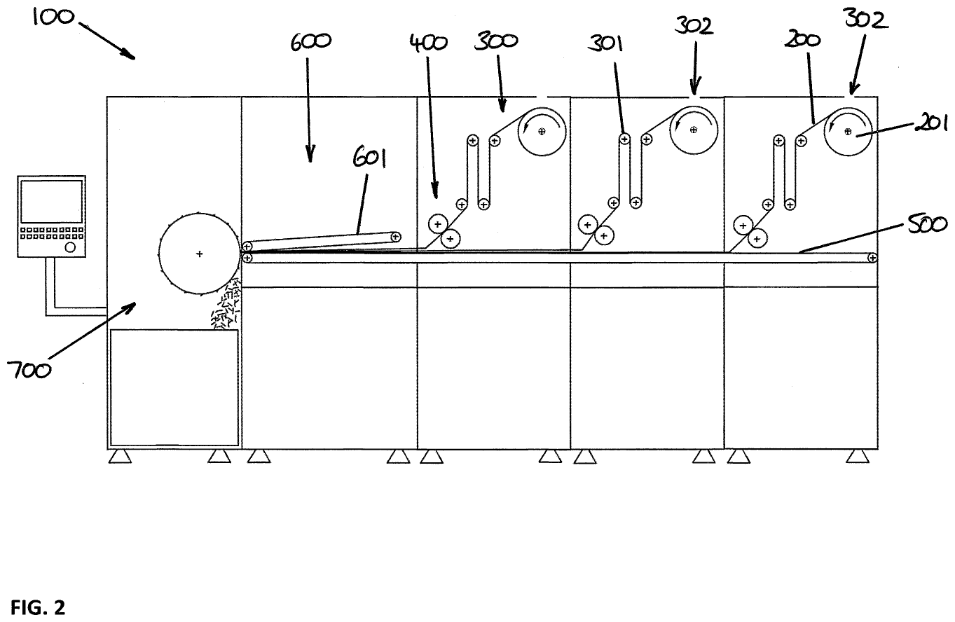

FIG. 2 shows a schematic view of an apparatus 100 for shredding a sheet of material 200. The apparatus comprises five main sections: unwinding section 300, perforating section 400, collecting conveyor 500, holding conveyor 600 and cutting section 700.

The sheet of material 200 is provided in the form of a plurality of rolls or bobbins 201, each of which is unwound in a respective unwinding section 300 to provide a substantially continuous sheet or web of material which travels through the apparatus 100 in a machine direction.

Each web of material 200 is fed from a respective roll 201 via a plurality of tensioning rollers 301. Vapor extraction points 302 may be provided, for example if the material contains a substance which emits a strong odour such as menthol. Each web 200 is fed to perforating section 400, described in more detail below. In this example, each web is unwound and perforated individually. Collecting conveyor 500 collects and combines the three perforated webs together to form a multi-layered, perforated web which is fed to the holding conveyor 600. In the holding conveyor 600, an additional conveyor 601 is provided above the combined webs, which gradually compresses the webs together before they reach the cutting section 700. Cutting section 700 will be described in more detail below.

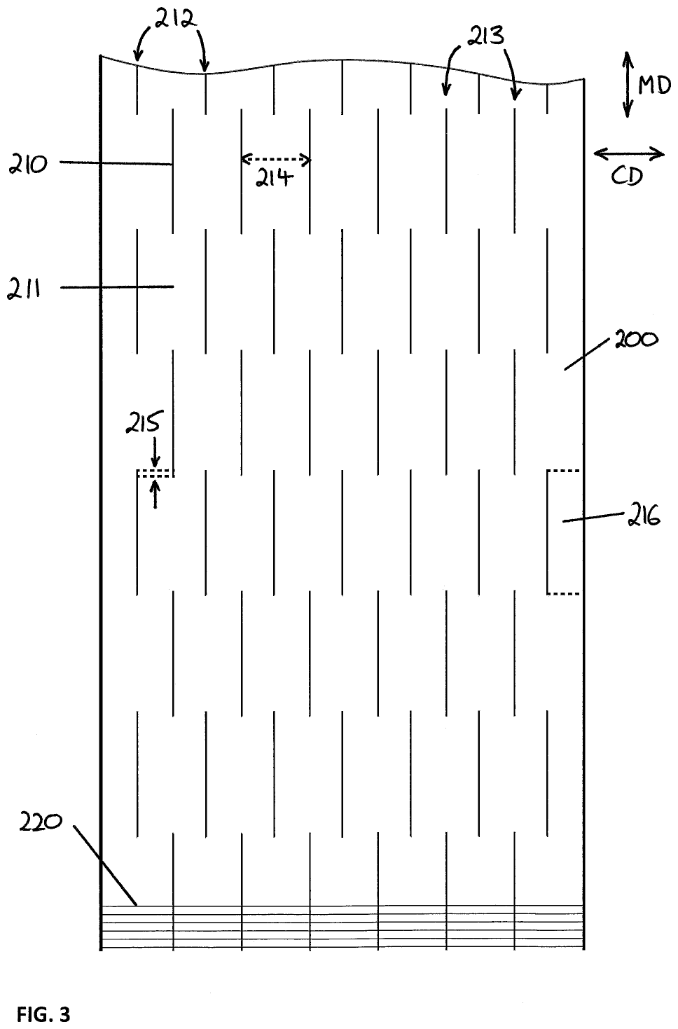

FIG. 3 shows schematically the operations carried out on the sheet 200 as it moves through the apparatus in accordance with an embodiment in which the perforation is carried out in the machine direction (arrow labelled MD) and the cutting is carried out in the cross direction (arrow labelled CD).

In the perforating section 400, the sheet 200 is perforated with a plurality of perforations 210. The perforations are formed in lines running in the machine direction. Each line comprises a sequence of alternating perforations 210 and gaps 211. A first group 212 of alternate lines of perforations have their perforations aligned in the cross direction. A second group 213 of alternate lines of perforations also have their perforations aligned in the cross direction, however the perforations of the second group are offset from those of the first group in the machine direction. In FIG. 3, the perforations of the second group 213 are fully offset so that the centre of each perforation in this group is aligned (in the cross direction) with the centre of each gap in the first group 212.

The distance in the cross direction between lines of the same group is the target length 214 of the shredded strips, as discussed above. As also discussed above, a degree of overlap 215 (in the machine direction, not to scale) can be provided to avoid strips greater than the target length. Strips between the overlapping portions of adjacent perforations will have half the target length. Strips generated from the regions such as 216 between the outermost lines of perforations and the edge of the sheet will also have a length which is less than the target length. The outermost perforations can be configured such that the strips produced from these edge regions also have half the target length. This will avoid strips of other lengths less than the target length being present in the final mixture. As discussed above, a proportion of strips of half the target length is acceptable.

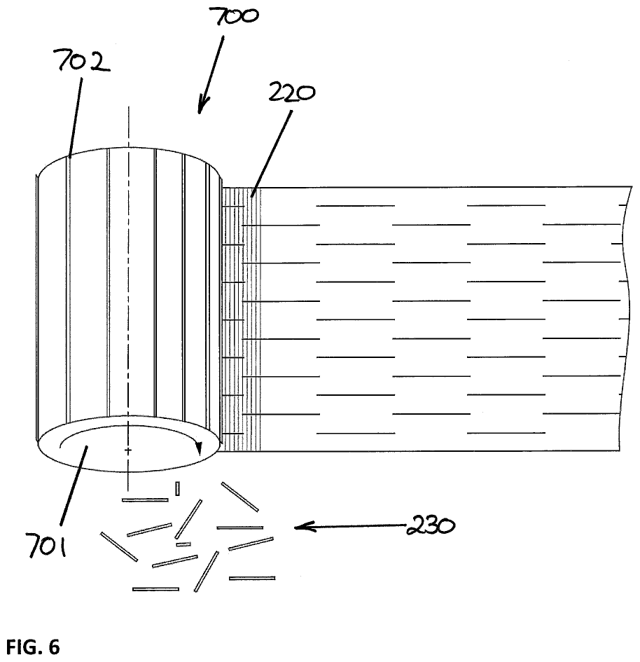

In the cutting section 700, the perforated sheet is cut in the cross direction by means of cut lines across the width of the sheet shown schematically as 220. Individual strips of material 230 (FIG. 6) are formed. The length of each strip is either the target length or half the target length. The width of each strip depends on the frequency of the cuts in the cross direction and the speed of the advancing perforated sheet.

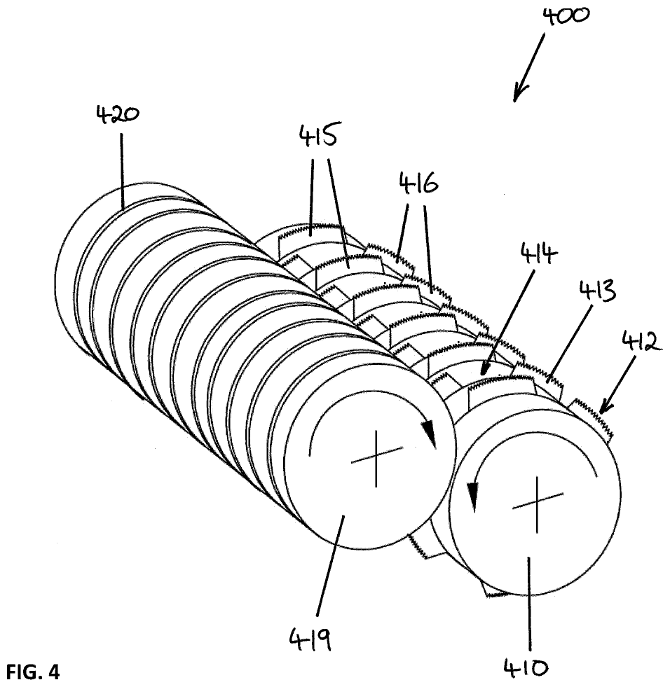

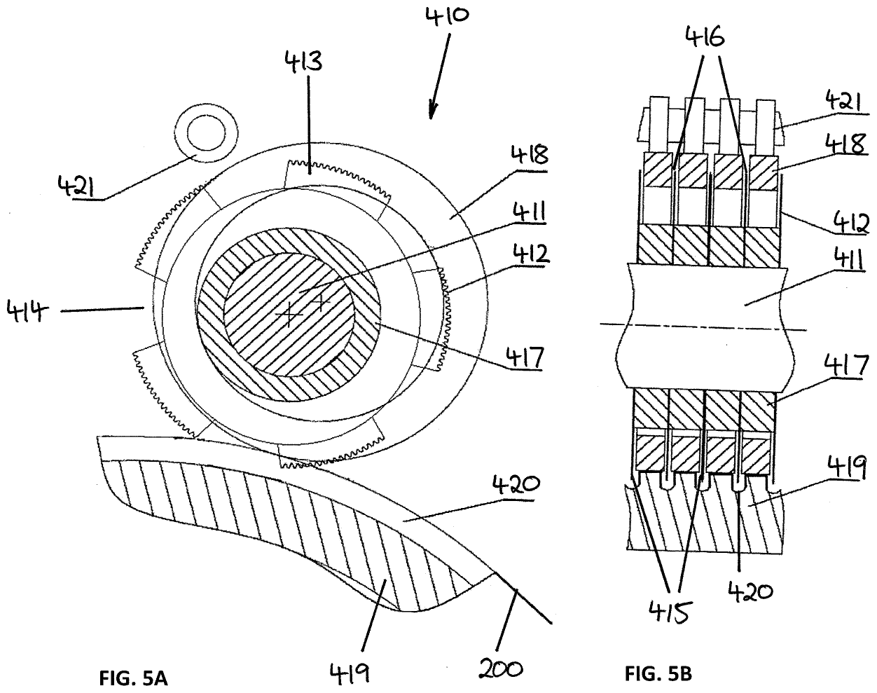

FIGS. 4 and 5 show one of the perforating sections 400 which perforates a sheet 200 as shown in FIG. 3. As mentioned above, the perforating section is a modified version of the apparatus disclosed in EP 2078464.

The apparatus comprises a perforating shaft shown generally as 410. Perforating shaft 410 comprises a driving shaft 411 and a plurality of perforating discs 412, each of which is keyed to the shaft. Each disc is provided with a plurality of blades 413, in this case five blades, each blade circumferentially spaced from the adjacent blade on the disc by a gap 414. A first group 415 of alternate discs across the perforating shaft have their blades aligned in the cross direction. A second group 416 of alternate discs across the perforating shaft also have their blades aligned in the cross direction, however the blades of the second group are offset from those of the first group in the machine direction. The discs 412 are spaced from each other by distance rings 417.

A loose cleaning ring 418 is provided between each adjacent pair of perforating discs 412. As can be seen in FIG. 5A, each cleaning ring is held in an off-axial position which is not coaxial with the axis of the driving shaft, by means of contact with supporting shaft 419 and directional shaft 421. In this way, the blades 413 are exposed in a position close to the supporting shaft, where the sheet 200 passes between the perforating shaft 410 and the supporting shaft 419, and are covered by the cleaning rings 418 when the blades are distal from the supporting shaft. As the blades rotate from the perforating position, the cleaning rings move radially outward relative to the blades and remove any sheet material remaining on the blades. The cutting edge of each blade is serrated.

The blades 413 project into grooves 420 provided in supporting shaft 419. Sheet 200 passes between the perforating shaft 410 and the supporting shaft 419 and is perforated in the manner described above.

Collecting conveyor 500 collects and combines the three perforated sheets together to form a multi-layered, perforated sheet which is fed to the holding conveyor 600 and on to the cutting section 700. Perforating each sheet individually and subsequently combining them for the second cut permits greater control of the quality and/or accuracy of the perforation. If multiple sheets are perforated together, the quality/accuracy can deteriorate for sheets lower down in the stack, further away from the perforating blade.

Referring to FIG. 6, cutting section 700 cuts the multiple perforated sheets simultaneously in the cross direction to form the individual strips of material 230. Cutting drum 701 comprises a plurality of blades 702 aligned in the cross direction, parallel to the axis of rotation of the drum, which cut the sheets to a predetermined length in the machine direction (which is the width of each strip) as each blade passes the feed-in point. The width of each strip depends on the frequency of the cuts in the cross direction (i.e. the speed of rotation of the drum 701) and the speed of the advancing perforated sheet, which is determined by the speed of conveyors 500/600. Either of these speeds may be controlled to maintain or adjust the width of each strip.

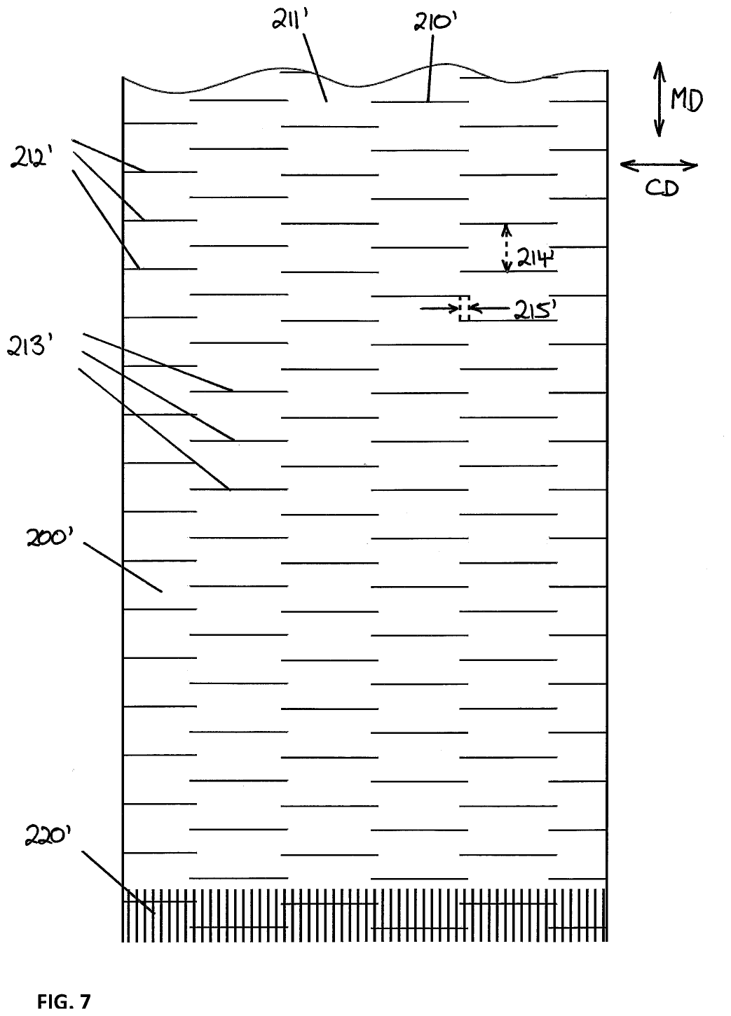

FIG. 7 shows schematically the operations carried out on the sheet 200 as it moves through the apparatus in accordance with an alternative embodiment in which the perforation is carried out in the cross direction (arrow labelled CD) and the cutting is carried out in the machine direction (arrow labelled MD).

In the perforating section 400, the sheet 200′ is perforated with a plurality of perforations 210′. The perforations are formed in lines running in the cross direction. Each line comprises a sequence of alternating perforations 210′ and gaps 211′. A first group 212′ of alternate lines of perforations have their perforations aligned in the machine direction. A second group 213′ of alternate lines of perforations also have their perforations aligned in the machine direction, however the perforations of the second group are offset from those of the first group in the cross direction. In FIG. 7, the perforations of the second group 213′ are fully offset so that the centre of each perforation in this group is aligned (in the machine direction) with the centre of each gap in the first group 212′.

The distance in the machine direction between lines of the same group is the target length 214′ of the shredded strips, as discussed above. As also discussed above, a degree of overlap 215′ (in the cross direction, not to scale) can be provided to avoid strips greater than the target length. Strips between the overlapping portions of adjacent perforations will have half the target length. As discussed above, a proportion of strips of half the target length is acceptable. The target length depends on the frequency of the perforations in the cross direction (i.e. the speed of operation of the perforating section) and the speed of the advancing material sheet. Either of these speeds may be controlled to maintain or adjust the length of each strip.

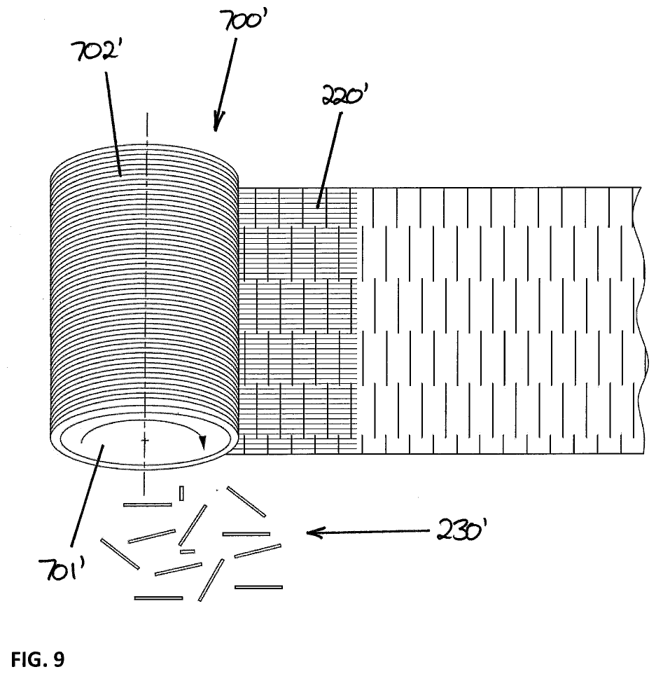

In the cutting section 700, the perforated sheet is cut in the machine direction by means of cut lines across the width of the sheet shown schematically as 220′. Individual strips of material 230′ (FIG. 9) are formed. The length of each strip is either the target length or half the target length. The width of each strip depends on the spacing between the machine direction cut lines.

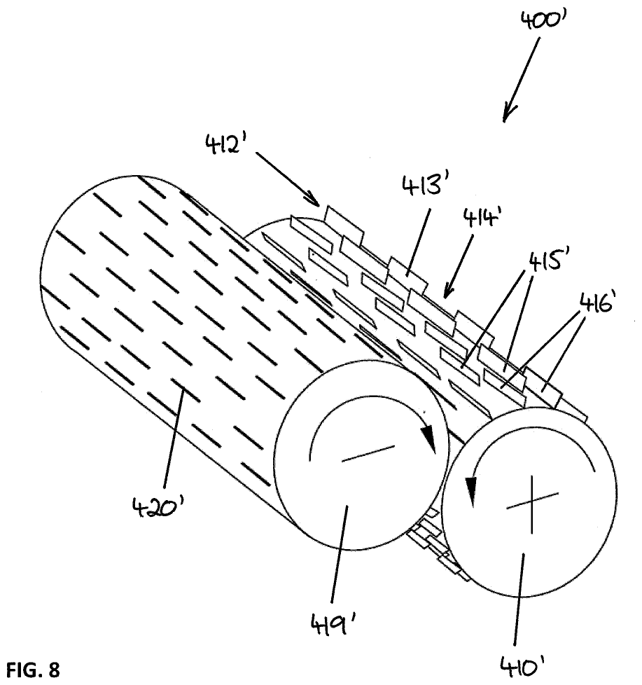

FIG. 8 shows one of the perforating sections 400′ which perforates a sheet 200′ as shown in FIG. 7. The apparatus comprises a perforating shaft shown generally as 410′. Perforating shaft 410′ comprises a plurality of lines 412′ of blades extending in the cross direction provided on the shaft, each line being circumferentially spaced from the adjacent line.

Each line comprises a plurality of blades 413′, each blade spaced from the adjacent blade in the line by a gap 414′. A first group 415′ of alternate lines around the perforating shaft have their blades aligned in the machine direction. A second group 416′ of alternate lines around the perforating shaft also have their blades aligned in the machine direction, however the blades of the second group are offset from those of the first group in the cross direction.

Sheet 200′ passes between the perforating shaft 410′ and the supporting shaft 419′. Each blade 413′ projects into a corresponding slot 420′ provided in the supporting shaft so that the sheet 200′ is perforated in the manner described above in relation to FIG. 7.

Collecting conveyor 500 collects and combines the three perforated sheets together to form a multi-layered, perforated sheet which is fed to the holding conveyor 600 and on to the cutting section 700′. Referring to FIG. 9, cutting section 700′ cuts the multiple perforated sheets simultaneously in the machine direction to form the individual strips of material 230′. Cutting drum 701′ comprises a plurality of blades 702′ aligned in the machine direction, perpendicular to the axis of rotation of the drum, which cut the sheets continuously in the machine direction to a predetermined width in the cross direction (which is the width of each strip).

At least in some embodiments, the invention provides an improved method and apparatus for shredding a sheet of material. Particularly when used to shred a sheet of material comprising an amorphous solid or dried gel, known “paper shredder” type processes involving two straightforward cuts in different directions have been found to cause the shredded material to clump and also material can build up on the shredding apparatus. The invention provides a process which, at least in some embodiments, reduces clumping, improves consistency of the strip properties, and provides a mechanism for keeping the perforating blades free of sheet material. Perforating first and then cutting in the orthogonal direction maintains the integrity of the sheet prior to and up to the second, final cut to form the individual strips. This facilitates handling of the perforated sheet, which may be in web form, and allows the sheet to be kept under a level of tension. The perforated sheet can therefore be transferred to the second cutting apparatus under tension, optionally having been combined with additional perforated webs prior to the final cutting operation. The two-stage cutting process, compared to the prior art “paper shredder” method in which the two cuts are essentially simultaneous, helps to reduce clumping or “birdnesting” of the shredded material. This is particularly beneficial when the material is relatively sticky, as in the case of the amorphous solid described above. The second, separate cut facilitates a staged release of the shredded material, with the strips all being substantially parallel as they are cut from the perforated web, which further reduces the chance of clumping or tangling.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

### REFERENCE NUMBER LIST

100 apparatus
200/200′ sheet of material
MD machine direction
CD cross direction
201 rolls of material
210/210′ perforations
211/211′ gaps
212/212′ first group of alternate lines of perforations
213/213′ second group of alternate lines of perforations (offset)
214/214′ target length
215/215′ overlap
216 region between perf and edge of sheet
220/220′ cut lines
230/230′ individual strips of material (shredded material)
300 unwinding section
301 tensioning rollers
302 vapor extraction points
400/400′ perforating section
410/410′ perforating shaft
411 driving shaft
412/412′ perforating disc/lines of blades
413/413′ blade
414/414′ gap
415/415′ first group of discs/alternate lines
416/416′ second group of discs/alternate lines (offset)
417 distance ring
418 cleaning ring
419 supporting shaft
420/420′ grooves/slots in supporting shaft
421 directional shaft
500 collecting conveyor
600 holding conveyor
601 compression conveyor
700/700′ cutting section
701/701′ cutting drum
702/702′ blades

1. A method of shredding a sheet of material comprising the steps of:
perforating the sheet in a first direction with a plurality of parallel lines of perforations to form a perforated sheet, wherein the perforations of adjacent lines are offset from one another; and
cutting the perforated sheet in a second direction to form individual strips of material.

2. The method of claim 1, wherein the first and second directions are orthogonal.

3. The method of claim 1, wherein the sheet of material is supplied in a machine direction and wherein the first direction is the machine direction and the second direction is the cross direction.

4. The method of claim 1, wherein the sheet of material is supplied in a machine direction and wherein the first direction is the cross direction and the second direction is the machine direction.

5. The method of claim 1, wherein the cut in the second direction is continuous.

6. The method of claim 1, wherein the perforations of adjacent lines are fully offset from one another.

7. The method of claim 1, wherein the perforations of alternate lines are aligned in the second direction.

8. The method of claim 1, wherein the perforations comprise a first group of alternate lines of perforations and a second group of alternate lines of perforations, wherein the perforations of the first group are aligned in the second direction, wherein the perforations of the second group are aligned in the second direction, and wherein the perforations of the second group are offset from the perforations of the first group in the first direction.

9. The method of claim 1 wherein the lines of perforations are equally spaced and wherein the distance between alternate lines of perforations is the target length for the strips of material.

10. The method of claim 1, wherein each line of perforations comprises a sequence of alternating cuts and gaps.

11. The method of claim 10, wherein the cuts are straight.

12. The method of claim 10, wherein the length of each cut is greater than the length of each gap to provide an overlap between perforations of adjacent lines when viewed in the second direction.

13. The method of claim 12, wherein the overlap, in relation to the length of the cut, is about 20% or less, 15% or less, 10% or less, 5% or less, 5-10%, 5-20%, 10-20%, or 15-20%.

14. The method of claim 12, wherein the overlap is about 5 mm or less, 4 mm or less, 3 mm or less, 2 mm or less, 1 mm or less, 5 mm-1 mm, 4 mm-1 mm, 3 mm-1 mm or 2 mm-1 mm.

15. The method of claim 1, wherein the sheet of material is a first sheet of material and the perforating step forms a first perforated sheet, further comprising the steps of:
separately perforating a second sheet of material in a first direction with a plurality of parallel lines of perforations to form a second perforated sheet, wherein the perforations of adjacent lines are offset from one another;
combining the first and second perforated sheets to form multiple layers of perforated sheets; and
cutting the multiple layers of perforated sheets in a second direction to form individual strips of material.

16. The method of claim 1, wherein the sheet of material comprises a material selected from: aerosol-generating material, aerosol-former material, tobacco, paper reconstituted tobacco, amorphous solid, dried gel.

17. The method of claim 1, wherein the sheet of material includes menthol.

18. Apparatus for shredding a sheet of material comprising:
a perforator configured to perforate the sheet in a first direction with a plurality of parallel lines of perforations, wherein the perforations of adjacent lines are offset from one another; and
a cutter configured to cut the perforated sheet in a second direction to form individual strips of material.

19. The apparatus of claim 18, wherein the first and second directions are orthogonal.

20. The apparatus of claim 18, wherein the sheet of material is supplied in a machine direction and wherein the first direction is the machine direction and the second direction is the cross direction.

21. The apparatus of claim 20, wherein the perforator comprises a plurality of blades spaced in the cross direction with each blade extending in the machine direction to form the lines of perforations.

22. The apparatus of claim 20, wherein each blade is rotatably mounted about an axis extending in the cross direction.

23. The apparatus of claim 22, wherein each line of perforations is formed by a plurality of blades arranged in a radial plane perpendicular to the axis of rotation.

24. The apparatus of claim 23, wherein the plurality of blades to form each line of perforations is provided on a disc.

25. The apparatus of claim 24, further comprising a cleaning ring between each disc of blades which is configured to remove material from a blade when the blade is distal from the sheet.

26. The apparatus of claim 24, wherein adjacent blades in the axial or cross direction are offset from each other in the machine direction to form the offset lines of perforations.

27. The apparatus of claim 24, comprising a first group of alternate discs and a second group of alternate discs, wherein the blades of the first group are aligned in the cross direction, wherein the blades of the second group are aligned in the cross direction, and wherein the blades of the second group are offset from the blades of the first group in the machine direction.

28. The apparatus of claim 24, wherein each disc of blades comprises a sequence of alternating blades and gaps.

29. The apparatus of claim 28, wherein the length of each blade is greater than the length of each gap to provide an overlap between perforations of adjacent lines when viewed in the second direction.

30. The apparatus of claim 18 , wherein the cutter comprises a blade configured to cut the sheet in the cross direction to form individual strips of material.

31. The apparatus of claim 30, wherein the blade is configured to cut the sheet continuously in the cross direction.

32. The apparatus of claim 30, wherein the cutter comprises a plurality of blades aligned in the cross direction which are rotatably mounted and spaced circumferentially.

33. The apparatus of claim 18, wherein the sheet of material is supplied in a machine direction and wherein the first direction is the cross direction and the second direction is the machine direction.

34. The apparatus of claim 33, wherein the perforator comprises a line of blades spaced in the cross direction with each blade extending in the cross direction to form a line of perforations across the sheet.

35. The apparatus of claim 34, wherein the line of blades is rotatably mounted about an axis extending in the cross direction.

36. The apparatus of claim 35, wherein the line of blades is provided on a cylinder.

37. The apparatus of claim 35, wherein a plurality of lines of blades are provided, each line being circumferentially spaced from the adjacent line and each forming a line of perforations.

38. The apparatus of claim 37, wherein adjacent lines of blades are offset from each other in the cross direction to form the offset perforations.

39. The apparatus of claim 37 , comprising a first group of alternate lines of blades and a second group of alternate lines of blades, wherein the blades of the first group are aligned in the machine direction, wherein the blades of the second group are aligned in the machine direction, and wherein the blades of the second group are offset from the blades of the first group in the cross direction.

40. The apparatus of claim 37, wherein each line of blades comprises a sequence of alternating blades and gaps.

41. The apparatus of claim 40, wherein the length of each blade is greater than the length of each gap to provide an overlap between perforations of adjacent lines when viewed in the second direction.

42. The apparatus of claim 33, wherein the cutter comprises a plurality of blades spaced in the cross direction and configured to cut the sheet in the machine direction to form individual strips of material.

43. The apparatus of claim 18, wherein the sheet of material is a first sheet of material and the perforator is a first perforator which forms a first perforated sheet, the apparatus further comprising:
a second perforator configured to perforate a second sheet of material in a first direction with a plurality of parallel lines of perforations to form a second perforated sheet, wherein the perforations of adjacent lines are offset from one another, wherein the apparatus is configured to combine the first and second perforated sheets to form multiple layers of perforated sheets; and
a cutter configured to cut the multiple layers of perforated sheets in a second direction to form individual strips of material.

44. An article comprising strips of material formed by the method of claim 1.

45. The article of claim 44, wherein the article is part of an aerosol provision system.

46. The article of claim 44, wherein the article is a consumable article for use with a non-combustible aerosol provision system.

47. The article of claim 44, wherein the strips of material comprise a proportion of strips having a first length and a proportion of strips having a second length which is less than the first length.

48. The article of claim 47, wherein the second length is half the first length.

49. The article of claim 48, wherein the proportion of strips having the second length compared to the total number of strips is 20% or less, 15% or less, 10% or less, 5% or less, 5-10%, 5-20%, 10-20% or 15-20%.
